(19) United States
(12) Patent Application Publication
(10) Pub. No.: US 2025/0145022 A1
(43) Pub. Date: May 8, 2025

(54) VEHICLE ENERGY OUTPUT CONTROL

(71) Applicant: FCA US LLC, Auburn Hills, MI (US)

(72) Inventors: Ali Abdulsaid, Northville, MI (US); Gregory M Klett, Holly, MI (US); Francis J Carr, II, Lake Orion, MI (US); John G Buchanan, IV, Wixom, MI (US); Vanessa K Vitso, Ypsilanti, MI (US)

(21) Appl. No.: 18/500,704

(22) Filed: Nov. 2, 2023

(51) Int. Cl. B60L 15/20; B60K 31/00; B60L 7/18

(52) U.S. Cl. CPC B60L 15/2045; B60K 31/00; B60L 7/18; B60K 2031/0091

(57) ABSTRACT

In at least some implementations, a method for controlling energy use in a vehicle includes determining a travel path for a trip, determining a duration of travel for the trip, determining an energy requirement to complete the trip within the duration, comparing the energy requirement to a low energy threshold, and reducing the maximum energy output that is provided from the vehicle when the energy requirement is lower than the low energy threshold.

### FIELD

The present disclosure relates to methods to control energy output from a prime mover of a vehicle.

### BACKGROUND

Some vehicles, and many electric vehicles in particular, have high power output and are capable of fast acceleration and high travel speeds. However, faster acceleration and travel increases energy consumption and the cost to operate the vehicle. Some vehicles are used to deliver items to customers, and a vehicle may have a delivery route including many delivery destinations, and an allotted time in which the deliveries are to occur. It is difficult to balance the need to meet time deadlines for deliveries and also manage energy consumption of the vehicle.

### SUMMARY

In at least some implementations, a method for controlling energy use in a vehicle includes determining a travel path for a trip, determining a duration of travel for the trip, determining an energy requirement to complete the trip within the duration, comparing the energy requirement to a low energy threshold, and reducing the maximum energy output that is provided from the vehicle when the energy requirement is lower than the low energy threshold.

In at least some implementations, the reducing step occurs when the energy requirement is less than the low energy threshold by at least a predetermined amount. In at least some implementations, the reducing step is accomplished by reducing a maximum rate of acceleration of the vehicle. In at least some implementations, the maximum rate of acceleration of the vehicle varies as a function of a speed limit of a road on which the vehicle travels along the route.

In at least some implementations, the reducing step is accomplished by reducing a maximum speed of the vehicle. In at least some implementations, the reducing step includes reducing a permitted speed of the vehicle as a function of a speed limit of a road on which the vehicle travels along the route.

In at least some implementations, the trip includes multiple legs each having a destination and wherein each leg is completed when the destination for that leg is reached by the vehicle, and each step of the method is performed again after the vehicle reaches at least one destination. In at least some implementations, the trip is completed when the vehicle reaches a final destination and wherein each step of the method is performed again after the vehicle reaches each destination that is not the final destination.

In at least some implementations, each step of the method is performed periodically as the vehicle moves along the travel path.

In at least some implementations, the method also includes comparing an energy level available in the vehicle to the energy requirement, and doing one or both of reducing the vehicle power output or increasing a regenerative braking level of the vehicle when the energy requirement is greater than the energy level available in the vehicle.

In at least some implementations, the energy requirement is determined in part based upon a weight of the vehicle, and wherein the vehicle is a delivery vehicle and the route includes multiple destinations with a delivery made at each destination resulting in a corresponding weight reduction of the vehicle.

In at least some implementations, a system for controlling energy consumption in a vehicle includes a supply of electrical energy, a prime mover including one or more electric motors connected to the supply, the prime mover having an output arranged to cause motion of the vehicle, a throttle input coupled to the prime mover and movable to change a power output of the prime mover, and a control system connected to one or both of the prime mover and the throttle input. The control system includes at least one processor and memory including instructions for operation of the prime mover in response to movement of the throttle input. The control system is responsive to trip information relating to a travel path to be taken by the vehicle to limit the power output from the prime mover, and the trip information includes data from which can be determined an energy requirement for the vehicle to complete a trip within an allotted time. The power output that can be provided from the prime mover is reduced when the energy requirement is less than a threshold.

In at least some implementations, the throttle input is movable by a driver of the vehicle to change the power output of the prime mover, and wherein the control system reduces the magnitude of the power output from the prime mover for a given magnitude of movement of the throttle input.

In at least some implementations, the control system is operable to reduce power output of the prime mover by limiting a speed obtainable by the vehicle.

In at least some implementations, the threshold is a level of energy remaining in the supply. In at least some implementations, the power output that can be provided from the prime mover is reduced when the energy remaining in the supply is less than the energy requirement.

In at least some implementations, the threshold is a low-power level that is at least 30% less than the maximum power output of the prime mover such that the power output that can be provided from the prime mover is reduced if the trip can be completed within the allotted time at the low-power level.

In at least some implementations, a regenerative braking system is coupled to the supply to selectively provide electrical energy to the supply when the vehicle is slowing down, and the control system is communicated with the regenerative braking system to alter a braking routine of the vehicle and change an output of the regenerative braking system to increase the energy provided to the supply when the energy requirement is greater than an energy level of the supply.

Further areas of applicability of the present disclosure will become apparent from the detailed description, claims and drawings provided hereinafter. It should be understood that the summary and detailed description, including the disclosed embodiments and drawings, are merely exemplary in nature intended for purposes of illustration only and are not intended to limit the scope of the invention, its application or use. Thus, variations that do not depart from the gist of the disclosure are intended to be within the scope of the invention.

### BRIEF DESCRIPTION OF THE DRAWINGS

FIG. 1 is a diagrammatic view of a vehicle and a travel path for the vehicle including multiple destinations or stops;

FIG. 2 is a diagrammatic view of systems of the vehicle and optional remote systems; and

FIG. 3 is a flowchart of a method for controlling power output of the vehicle.

### DETAILED DESCRIPTION

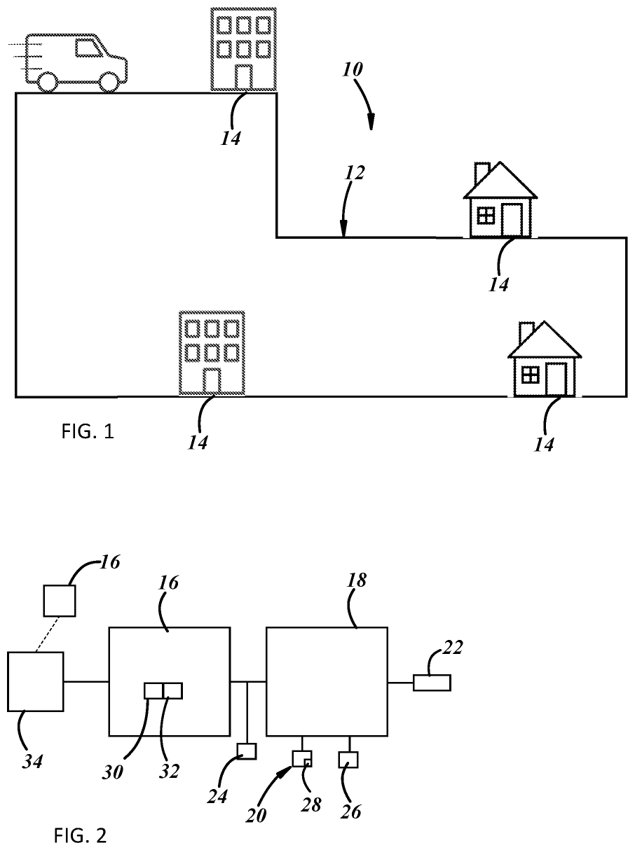

Referring in more detail to the drawings, FIG. 1 illustrates a vehicle 10 and a travel path 12 for the vehicle 10 that includes multiple destinations or stops 14. In the example shown, the vehicle 10 is a delivery truck and the travel path 12 includes four stops 14 for deliveries at different establishments, such as homes, apartments, office buildings, and the like. The travel path 12 may include different types of roads, like city roads, rural roads, highways or other higher speed roads, that have different road conditions like speed limits, construction zones, intersections and stopping points which may be defined by traffic signs or traffic lights, for example. In addition to road conditions, the roads may have traffic levels that vary over time and may reduce travel speed as well as the number of stopping, braking and acceleration events when traveling on a road at a given time.

Various navigation programs 34 are known, as are commercial fleet vehicle logistical programs, that compute a travel path 12 and convey information about the travel path 12 to a driver and/or a control center for a fleet of vehicles. The navigation programs 34 can use information relating to road conditions and traffic to define travel paths 12 that are shortest in length or time, or that avoid certain road types or area where travel time is less certain, for example, construction zones. The navigation programs 34 may be integrated into a vehicle control system 16 (FIG. 2) or infotainment system, and/or can be resident on a mobile device that is connected to the vehicle 10 by wired or wireless connection.

As shown in FIG. 2, the vehicle 10 includes a prime mover 18 that may include a combustion engine, one or more electric motors or both an engine and motor(s), as in a hybrid vehicle 10. The vehicle 10 also includes a brake system 20 that functions to slow and stop the vehicle 10. In the example of an electric or hybrid vehicle 10, one or more batteries define at least part of an energy supply 22 in which electrical energy is stored to power a motor, and a regenerative braking system 24 may be utilized to generate and store electrical energy while the vehicle speed is being reduced. The vehicle 10 includes a throttle input 26 (e.g. accelerator pedal) and a brake input 28 (e.g. brake pedal) that allow user controlled operation of the prime mover 18 and the brake system 20. The throttle and braking functions may also be done semi or fully autonomously, if desired.

To control various functions of the vehicle 10, the vehicle control system 16, among other things, controls operation of the prime mover 18 of the vehicle 10. For example, the vehicle 10 may include drive by wire and brake by wire systems and the control system 16 may be programmed or include instructions to respond to driver action, such as movement of the throttle and brake inputs 26, 28. The magnitude of the power output from the prime mover 18 and brake system 20 varies as a function of the driver input, as well as the instructions executed by the control system 16, which may vary in different circumstances and may be implemented in view of variables and by way of look-up tables, maps, algorithms and the like.

The control system 16 may include one or more controllers/processors 30 and memory 32 accessible to the processors 30, where the memory 32 and one or more processors 30 may be one or both integrated into the vehicle 10 or remotely located and wirelessly communicated to the vehicle 10, as desired. Further, the memory 32 may include data, programs, instructions and algorithms accessible to the processor(s) 30, and such information may be updated by wireless transmission to the control system 16, as desired.

In order to perform the prescribed functions and desired processing, as well as the computations therefore (e.g., vehicle 10 energy control such as acceleration and braking control, control algorithm(s), and the like), the control system 16 or one or more controllers may include, but not be limited to, a processor(s) 30, computer(s), DSP(s), memory 32, storage, register(s), timing, interrupt(s), communication interface(s), and input/output signal interfaces, and the like, as well as combinations comprising at least one of the foregoing. For example, processors or controllers may include input signal processing and filtering to enable accurate sampling and conversion or acquisitions of such signals from sensors and communications interfaces.

As used herein the terms control system 16 or controller or processor 30 may refer to one or more processing circuits such as an application specific integrated circuit (ASIC), an electronic circuit, a processor 30 (shared, dedicated, or group) and memory 32 that stores data/files and permits execution of one or more software or firmware programs, a combinational logic circuit, and/or other suitable components that provide the described functionality.

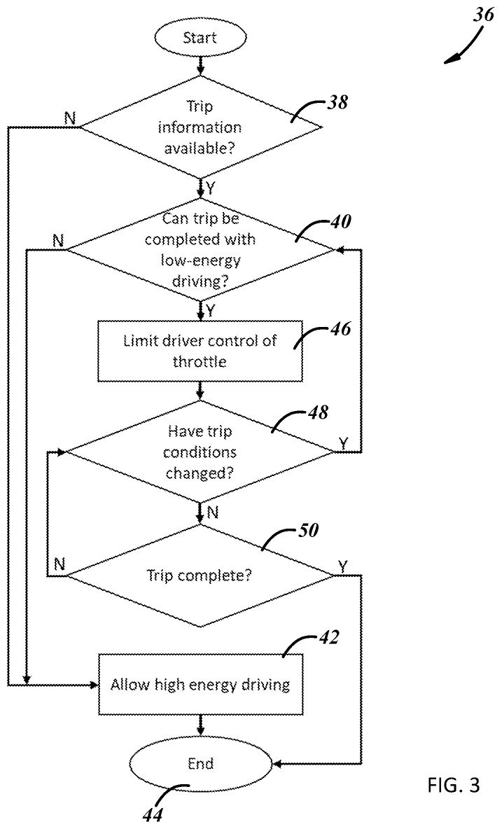

FIG. 3 illustrates a method 36 for selectively limiting energy output of the prime mover 18 of the vehicle 10. In step 38, the control system 16 determines if sufficient information about the trip to be completed is available. The trip information includes data about a selected travel path 12, including stops 14 along the travel path 12. This data may include road conditions for each portion of the travel path 12, traffic, weather and other information that affects the duration of the trip, vehicle 10 speed and vehicle 10 stopping and acceleration events. From the trip information, the control system 16 may determine an energy level needed to complete the trip, including all stops 14 and in view of the selected travel path 12.

In at least some implementations, the energy level needed to complete the trip is determined at least in part based on the time needed for part or all of the trip, to ensure that the trip can be completed by an indicated deadline. In some instances, the time to complete the trip may require faster vehicle 10 operation to complete the trip by the deadline in view of the travel path 12 and estimated future conditions affecting the time to progress along the travel path 12. In some instances, the time to complete the trip can allow for slower vehicle operation.

So, one aspect of the energy level needed to complete the trip in a given amount of time is the rate of energy use, where energy use might not be linear over a range of acceleration rates. For example, in both combustion engines and electric motors, a greater and not linear rate of energy often is used to accelerate the vehicle 10 more rapidly than more slowly. So, in general terms and other variables being the same, a vehicle 10 that regularly is accelerated more rapidly uses more energy to travel a given distance than does a vehicle 10 that regularly is accelerated more slowly.

After determining an energy level needed to complete the trip in a given amount of time, or by a given time, the method 36 in step 40 determines if maximum or a high level of vehicle 10 power might be needed to complete the trip in the allotted time, or if a lower level of power can be used to complete the trip in the allotted time. The lower level of power might be a set or predetermined level of power, or other threshold. In one non-limiting example used solely for illustration, the lower power level might be at least 30% of the maximum power that may be output or provided from the prime mover 18. This might be torque or horsepower (or equivalent) and so, in this example, if the vehicle 10 has a maximum power output of 300 hp, then the determination is made whether the trip can be completed in the allotted time if the vehicle 10 is limited to a power output of 210 hp or less (e.g. a 50% reduction would be 150 hp). Again, the threshold can be different and need not be a fixed value. That is, the threshold may be variable and adjusted in view of different factors including, but not limited to, the type of vehicle 10, the type of roads in the travel path 12, number of estimated stops 14, number of estimated acceleration events, weather conditions, and the potential variability in these conditions along the travel path 12 and within the allotted time, as well as other factors and considerations. In this way, a given magnitude or amount of movement of the throttle input 26 will result in less power output from the prime mover 18 than would the same throttle input 26 movement without the power output reduction.

In the example method 36 of FIG. 3, if the energy level required to complete the trip is greater than the low-energy threshold, the method 36 continues to step 42, high energy driving is permitted and the method 36 may end at 44. Note that, rather than ending, the method 36 may return to step 38 after a threshold time delay or after occurrence of an event, like reaching a preset destination or stop 14 in the travel path 12, after which the method 36 may be run again.

If in step 40 it is determined that the trip can be completed with a lower energy of driving, then the method 36 continues to step 46 in which the vehicle 10 throttle response is limited. This may limit the maximum rate of acceleration of the vehicle 10, the maximum power output of the vehicle 10, the speed of the vehicle 10 or any combination of these including all of them. The speed may be regulated as a function of the speed limit of a road on which the vehicle 10 is traveling, by way of one non-limiting example. The throttle limitation may be determined to decrease power use and increase the range of the vehicle 10, while still providing sufficient power output to permit the trip to be completed by the deadline.

Periodically (e.g. at desired time intervals) or after occurrence of an event, like reaching a preset destination or stop 14 in the travel path 12, the method 36 may continue to step 48 in which it may be determined if the trip conditions have changed sufficiently to necessitate a change in the throttle limitation that was implemented. This may be done in the same manner as for step 40, if desired, or this step may involve determining if one or more conditions have changed sufficiently to warrant a review of the original determination to implement the throttle limitation. In at least some implementations, the navigation program provides an estimated trip completion time that is updated based upon real-time traffic and road conditions, and if the trip completion time changes by more than a threshold, then it is determined that the trip conditions have changed sufficient for a review of the throttle limitation.

If the trip conditions have changed sufficiently then the method 36 may return to step 40 to determine if the remainder of the trip can be completed by the deadline. If yes, the throttle limitation can remain or be updated to a new threshold or setting, as desired. If the trip conditions have not changed sufficiently then the method 36 may continue to step 50 in which it is determined if the trip is complete. If the trip is not complete, the method 36 may return to step 48 after some time delay or occurrence of an event, or otherwise, as desired. If the trip is complete, then the method 36 may end at 44.

In at least some implementations, a method 36 for controlling energy use in a vehicle 10 includes determining a travel path 12 and a duration for a trip, determining an energy requirement to complete the trip within the duration, comparing the energy requirement to a low energy threshold, and reducing the maximum energy output that is provided from the vehicle 10 when the energy requirement is lower than the low energy threshold. Reducing the maximum energy output may be accomplished in different ways, such as by reducing a maximum rate of acceleration of the vehicle 10, or reducing a maximum speed of the vehicle 10 by way of a couple examples. The maximum acceleration and/or speed reduction or control may be determined as a function of a speed limit of one or more roads on which the vehicle 10 travels along the travel path 12. Further, as noted above, the method 36 may be run more than once for a given trip, and in at least some implementations, the trip includes multiple legs each having a destination, and the method 36 may be performed again after the vehicle 10 reaches at least one destination, or after the vehicle 10 reaches each destination that is not the final destination, or periodically or otherwise as desired.

Further, the energy level or power output to which the vehicle 10 is restricted can be preselected as a percentage of the vehicle maximum power output, or it can be determined as a function of one or more factors. The factors may include, for example, the total energy required to complete the trip where the power reduction may be done to ensure that the trip can be completed, which may include a factor of safety to increase the likelihood that the trip can be completed if more than a determined amount of energy is needed. That is, the energy available in the vehicle 10 can be compared to the energy required to complete the trip, and the power output of the vehicle 10 controlled as a function of the available energy.

Thus, in at least some implementations, the method 36 may also include comparing an energy level available in the vehicle 10 to the energy requirement for completing the trip. This may be done to determine if sufficient energy remains to complete the trip under the current vehicle and trip conditions. If sufficient energy is not available in the vehicle 10, then the system may implement one or more energy saving or generating steps to increase the likelihood that the trip can be completed without having to refuel or recharge the vehicle 10. For example, the system may reduce the vehicle power output to increase the effective vehicle range that can be achieved with the remaining energy in the vehicle 10, or the system may change a braking routine of the vehicle 10 and increase a regenerative braking level of the vehicle 10 to increase the energy available within the vehicle 10, when the energy requirement for the remainder of a trip is greater than the energy level available in the vehicle 10. In this context, changing the braking routine of the vehicle 10 includes increasing the regenerative braking function to increase energy output form the system to the energy supply 22 (e.g. batteries). While this might increase the duration of the trip and may make the trip last longer than a planned duration or deadline, the increased likelihood of completing the trip with the remaining energy in the vehicle 10 may take priority over the duration, in at least some implementations.

In at least some implementations, the energy requirement may be determined in part based upon a weight of the vehicle 10, such as when the vehicle 10 is a delivery vehicle and the trip includes multiple destinations with a delivery to be made at each destination, resulting in a corresponding weight reduction of the vehicle 10. For delivery of larger items, the weight of the vehicle 10 may change significantly throughout a trip and the vehicle 10 would then require increasingly less energy to be driven as deliveries are made and the vehicle 10 is unloaded. Further, for such vehicles, a pre-mapped delivery route can be proactively determined based on the items to be delivered and the destination for each item, which aids in determining the conditions throughout the trip.

Additionally, the trip conditions, road conditions and the like may be provided by a navigation system or program as noted, or by other things. For example, the vehicle 10 may include on-board cameras and sensors that are used to assist in autonomous or semi-autonomous driving (e.g. within an Advanced Driver Assist System—ADAS). Such cameras and sensors may be used to detect lane lines, road signs, the state of traffic lights, and the like. Such systems may be useful in determining traffic levels near the vehicle 10, and signage that changes the normal speed limit for a portion of a road, such as may occur in a construction zone. This information can be used by the control system 16 and in the method 36 to determine the energy required for all or a portion of a trip. Further, the system may be used by an autonomous driving system whereby the vehicle 10 power output is controlled to adjust the computer-controlled driving behavior of the vehicle 10 rather than a human, driver-controlled driving behavior.

Still further, the term “trip” should be interpreted broadly and may include an entire trip from start to finish, or part of a trip, such as the portion remaining after completion of some part of the trip. In this way, the systems and method 36 are not limited only to initial determination of an energy mode of the vehicle 10 before a trip begins, but to such determination as may be made any time from the start to the finish of a trip.

The method 36 includes steps that may be carried out in a different order and by systems integrated into the vehicle 10, remote devices that communicate with the vehicle 10, or both. Further, more or fewer method 36 steps may be used in different implementations of the method 36, as desired. Although this disclosure directly noted delivery vehicles that commonly are routed to many destinations in a trip, the disclosure relates to any type of vehicle, and the vehicles may be used for any purpose.

The systems and methods described herein enable organizations, businesses and individuals to control the output provided from actuation of an accelerator pedal/throttle input 26 on their vehicles which may reduce energy consumption, reduce the energy cost, improve safety, reduce variability among drivers of fleet vehicles, and provide extended vehicle range. The systems and method 36 can be implemented interactively, throughout a trip and throughout a fleet of vehicles, and can integrate multiple modules or control systems/controllers, to intelligently determine and arbitrate the power output available to a driver. This may be done as a function of various conditions and information from various sources such as GPS, road signage, and commercial data (e-commerce shipment deliveries).

Vehicle control modules or control systems that could be used include, but are not limited to, EVCU (Electric Vehicle Control Unit), BSM (Brake system Module—which may control a regenerative braking system by which energy is generated as a vehicle 10 slows down), camera/radar systems by which road signs and traffic may be determined, for example, e-Commerce delivery platforms (Amazon, eBay, Fedex, UPS, etc) that define the destinations for various deliveries. For example, an Amazon delivery truck may have ten packages onboard to deliver within a four miles radius, and within a four-hour time period, while traffic in that area is fairly light permitting reliable drive times between destinations. In this scenario, the system may determine that reaching each destination within the time period can be accomplished somewhat easily and so the system may restrict the power output to remain at or under 50% of a maximum vehicle power output to conserve the energy/fuel of the vehicle 10. Of course, this is just one simple example and other implementations may be used.

What is claimed is:

1. A method for controlling energy use in a vehicle, comprising:
determining a travel path for a trip;
determining a duration of travel for the trip;
determining an energy requirement to complete the trip within the duration;
comparing the energy requirement to a low energy threshold; and
reducing the maximum energy output that is provided from the vehicle when the energy requirement is lower than the low energy threshold.

2. The method of claim 1 wherein the reducing step occurs when the energy requirement is less than the low energy threshold by at least a predetermined amount.

3. The method of claim 1 wherein the reducing step is accomplished by reducing a maximum rate of acceleration of the vehicle.

4. The method of claim 1 wherein the reducing step is accomplished by reducing a maximum speed of the vehicle.

5. The method of claim 1 wherein the reducing step includes reducing a permitted speed of the vehicle as a function of a speed limit of a road on which the vehicle travels along the route.

6. The method of claim 3 wherein the maximum rate of acceleration of the vehicle varies as a function of a speed limit of a road on which the vehicle travels along the route.

7. The method of claim 1 wherein the trip includes multiple legs each having a destination and wherein each leg is completed when the destination for that leg is reached by the vehicle, and each step of the method is performed again after the vehicle reaches at least one destination.

8. The method of claim 7 wherein the trip is completed when the vehicle reaches a final destination and wherein each step of the method is performed again after the vehicle reaches each destination that is not the final destination.

9. The method of claim 1 wherein each step of the method is performed periodically as the vehicle moves along the travel path.

10. The method of claim 1 which also includes comparing an energy level available in the vehicle to the energy requirement, and doing one or both of reducing the vehicle power output or increasing a regenerative braking level of the vehicle when the energy requirement is greater than the energy level available in the vehicle.

11. The method of claim 1 wherein the energy requirement is determined in part based upon a weight of the vehicle, and wherein the vehicle is a delivery vehicle and the route includes multiple destinations with a delivery made at each destination resulting in a corresponding weight reduction of the vehicle.

12. A system for controlling energy consumption in a vehicle, comprising:
a supply of electrical energy;
a prime mover including one or more electric motors connected to the supply, the prime mover having an output arranged to cause motion of the vehicle;
a throttle input coupled to the prime mover and movable to change a power output of the prime mover; and
a control system connected to one or both of the prime mover and the throttle input, the control system includes at least one processor and memory including instructions for operation of the prime mover in response to movement of the throttle input, wherein the control system is responsive to trip information relating to a travel path to be taken by the vehicle to limit the power output from the prime mover, and wherein the trip information includes data from which can be determined an energy requirement for the vehicle to complete a trip within an allotted time, and wherein the power output that can be provided from the prime mover is reduced when the energy requirement is less than a threshold.

13. The system of claim 12 wherein the throttle input is movable by a driver of the vehicle to change the power output of the prime mover, and wherein the control system reduces the magnitude of the power output from the prime mover for a given magnitude of movement of the throttle input.

14. The system of claim 12 wherein the control system is operable to reduce power output of the prime mover by limiting a speed obtainable by the vehicle.

15. The system of claim 12 wherein the threshold is a level of energy remaining in the supply.

16. The system of claim 15 wherein the power output that can be provided from the prime mover is reduced when the energy remaining in the supply is less than the energy requirement.

17. The system of claim 12 wherein the threshold is a low-power level that is at least % less than the maximum power output of the prime mover such that the power output that can be provided from the prime mover is reduced if the trip can be completed within the allotted time at the low-power level.

18. The system of claim 12 which also includes a regenerative braking system coupled to the supply to selectively provide electrical energy to the supply when the vehicle is slowing down, and wherein the control system is communicated with the regenerative braking system to alter a braking routine of the vehicle and change an output of the regenerative braking system to increase the energy provided to the supply when the energy requirement is greater than an energy level of the supply.
